(19) United States
(12) Patent Application Publication
(10) Pub. No.: US 2009/0021206 A1
(43) Pub. Date: Jan. 22, 2009

(54) Motor soft start-up system

(76) Inventor: Kuo-Lung Kuan, Taichung City (TW)

Correspondence Address: PRO-TECHTOR INTERNATIONAL SERVICES, 20775 NORADA CT., SARATOGA, CA, 95070, US

(21) Appl. No.: 11/879,287

(22) Filed: Jul. 17, 2007

(51) Int. Cl. H02P 1/00

(52) U.S. Cl. 318/778

(57) ABSTRACT

A soft start-up system for a motor that minimizes formation of surge and effectively contains its impacts upon any other source voltage in the peripheral to further promote safe power consumption is mounted on a motor source circuit and includes a power resistance and a relay; the power resistance is electrically connected in series to the motor; and the relay is connected in parallel with the motor and has a contact connected in parallel with the power resistance. Upon starting up of the motor, a drop generated at a working point to create delayed LV soft start-up for the motor under the condition of the activation point of the relay is OFF; and once the motor is started up, amperage drops and the relay is triggered off by returning to a working voltage connected in parallel to the relay, source at the working contact is conducted ON for the motor to resume its normal operation status.

### BACKGROUND OF THE INVENTION

(a) Field of the Invention

The present invention is related to a motor soft start-up system, and more particularly, to one that reduces surge, minimizes impacts upon peripheral source voltages, and permits safer use of electric power.

(b) Description of the Prior Art

As illustrated in FIG. 1 of the accompanying drawings, starting up a motor of the prior art connected to city power is usually done by operating a power switch 11 provided on a power circuit. When the power switch 11 is turned to ON position to conduct through, a motor 10 achieves instantaneous start-up upon having fast access to power supply; however, as illustrated in FIG. 2, a surge presents due to counter electromotive force (CEMF). The surge could cause voltage drop to and affect any other power consumption machinery and equipment located in the vicinity of in the perimeter of the motor 10, and in severe case, put power consumption safety of the entire environment at risk.

### SUMMARY OF THE INVENTION

The primary purpose of the present invention is to provide a soft start-up system for a motor that minimizes formation of surge and effectively contains its impacts upon any other source voltage in the peripheral to further promote safe power consumption. To achieve the purpose, the present invention is provided on a motor source circuit and includes a power resistance and a relay. The power resistance is electrically connected in series to the motor; and the relay is connected in parallel with the motor and has a contact connected in parallel with the power resistance. Upon starting up of the motor, a drop generated at a working point where the relay is connected in parallel between the power resistance and the motor through a limiting action by the power resistance connected in series to the power circuit, and the drop creates delayed LV soft start-up for the motor under the condition of the activation point of the relay is OFF; and once the motor is started up, amperage drops and the relay is triggered off by returning to a working voltage connected in parallel to the relay, source at the working contact is conducted ON for the motor to resume its normal operation without being subject to limiting current.

Another purpose of the present invention is to provide a soft start-up system for a motor that is capable of setting up a resistance value for the power resistance according to power consumption conditions of the motor to reach the expected current limitation. To achieve the purpose, the power resistance is connected in series with the motor and the power resistance executes current limitation upon the motor when first started up; and the power resistance may be related to a variable power resistance.

### BRIEF DESCRIPTION OF THE DRAWINGS

FIG. 1 is a schematic view showing a power circuit for a motor of the prior art.

FIG. 2 is a schematic view showing a power consumption status of the motor of the prior art.

FIG. 3 is a schematic view of a circuit of the present invention.

FIG. 4 is a schematic view showing a power consumption status of a motor of the present invention.

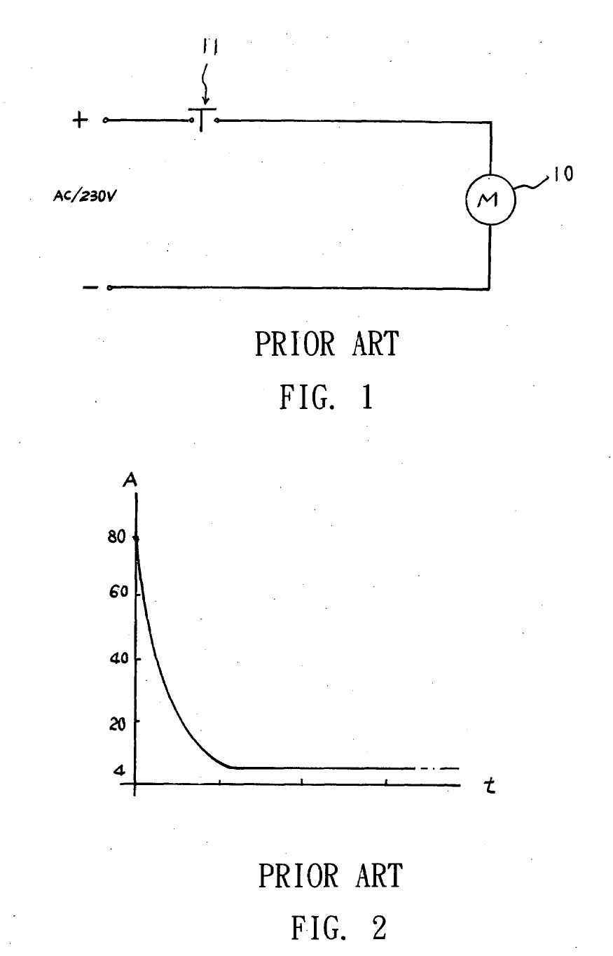

### DETAILED DESCRIPTION OF THE PREFERRED EMBODIMENTS

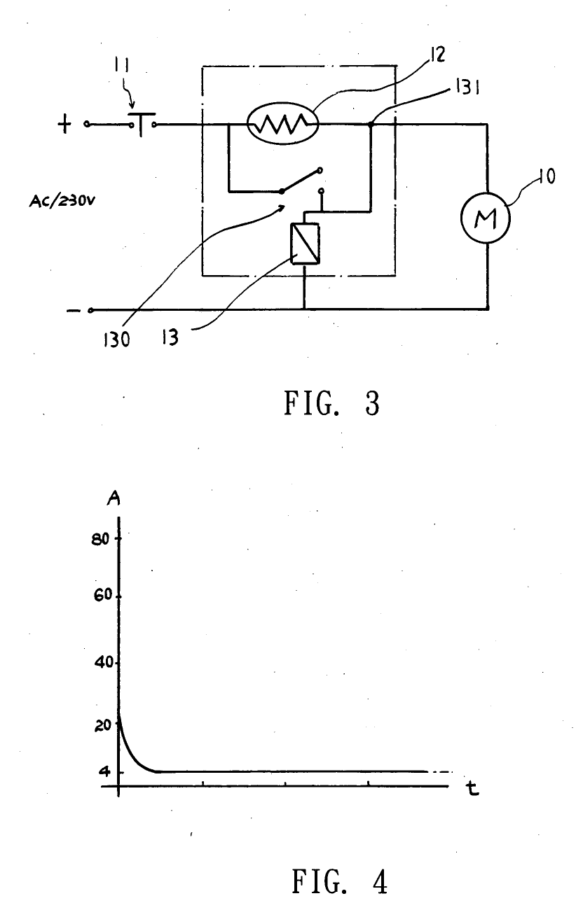

Referring to 3, a motor soft start-up system is mounted to a power circuit of the motor 10, comprising a power resistance 12 and a relay 13. The power resistance 12 is electrically connected in series with the motor 10; and the relay is connected in parallel with the motor 10 and has a working contact 130 connected in parallel with the power resistance. Once a power switch 11 is conducted ON and the motor 10 is just started up, a limiting function provided by the power resistance connected in series to the power circuit, a voltage drop takes place at a contact 131 of the relay connected in parallel between the power resistance 12 and the relay 13 causes the motor 10 to generate delayed LV soft start-up with the working connect 130 of the relay 13 in OFF status. As illustrated in FIG. 4, after the motor 10 is started up, current A drops and as illustrated in FIG. 3, the parallel contact 131 of the relay returns to its working voltage to trigger off the relay 13 to operate, and the source at the working contact 130 is conducted ON for the motor 10 to return to its normal operation status without being subject to current limitation. Accordingly, the present invention helps minimize formation of a surge upon starting up the motor 10, and protect any power voltage in the peripheral of the motor 10 from being affected by the start-up of the motor 10, thus to improve safety of power consumption.

As illustrated in FIG. 3, the power resistance 12 is connected in series to the motor 10 and to execute current limitation to the motor when started up. The power resistance 12 may be to a variable power resistance. Accordingly, a specific resistance may be set up for the power resistance 12 to achieve the expected current limitation depending on power consumption conditions of the motor 10.

What is claimed is:

1. A motor soft start-up system mounted to a power circuit of the motor, comprising a power resistance and a relay, the power resistance being electrically connected in series with the motor; the relay being connected in parallel with the motor; the relay having a working contact connected in parallel with the power resistance; a power switch being conducted ON to start up the motor; a limiting function provided by the power resistance connected in series to the power circuit; a voltage drop taking place at a contact of the relay connected in parallel between the power resistance and the relay causing the motor to generate delayed LV soft start-up with the working connect of the relay in OFF status; with the motor being started up, current drop taking place and the parallel contact of the relay returning to its working voltage to trigger off the relay to operate; the source at the working contact being conducted ON for the motor to return to its normal operation status without being subject to current limitation to minimize formation of a surge upon starting up the motor, and protect any power voltage in the peripheral of the motor 10 from being affected by the start-up of the motor for improved safety of power consumption.

2. The motor soft start-up system as claimed in claim 1, wherein the power resistance is connected in series to the motor 10 and to execute current limitation to the motor when started up; the power resistance is related to a variable power resistance; a specific resistance is set up for the power resistance to achieve the expected current limitation depending on power consumption conditions of the motor.
